(19) United States
(12) Patent Application Publication
(10) Pub. No.: US 2009/0007379 A1
(43) Pub. Date: Jan. 8, 2009

(54) AUTOMATICALLY OPENING HINGE ASSEMBLY FOR PORTABLE ELECTRONIC DEVICES

(75) Inventors: GUANG-XIANG ZHANG, Shenzhen (CN); SHI-JIN LONG, Shenzhen (CN); XI-QIU WU, Shenzhen (CN); GENG-HUI GUO, Shenzhen (CN); CHIH-WEI SU, Shindian (TW); HSIAO-HUA TU, Shindian (TW)

Correspondence Address: PCE INDUSTRY, INC.;ATT. CHENG-JU CHIANG, 458 E. LAMBERT ROAD, FULLERTON, CA, 92835, US

(73) Assignees: SHENZHEN FUTAIHONG PRECISION INDUSTRY CO., LTD., ShenZhen City (CN); SUTECH TRADING LIMITED, Tortola (VG)

(21) Appl. No.: 11/946,340

(22) Filed: Nov. 28, 2007

(30) Foreign Application Priority Data
Jul. 6, 2007 (CN) 200710075836.8

(51) Int. Cl. E05F 1/08; E05D 11/10; H04M 9/00

(52) U.S. Cl. 16/295; 16/296; 16/297; 16/305; 16/307

(57) ABSTRACT

A hinge assembly (100) includes a main shaft (50), a fixing seat (80), a follower (44), a cam (42) and a first elastic element (30). The fixing seat is fixed with the main shaft. The follower is placed around the shaft, and the fixing seat selectively locks with the follower. The cam is placed around the shaft, and engages with the follower. The first elastic element provides an elastic force to make the cam and the follower resist each other and provides a torsional force to make the cam and the follower rotate together.

### BACKGROUND OF THE INVENTION

1. Field of the Invention

The present invention relates to hinge assemblies and, particularly, to an automatic opening hinge assembly for foldable devices such as mobile phone, personal digital assistant (PDA), and so on.

2. Discussion of the Related Art

With the development of wireless communication and information processing technologies, foldable electronic devices such as mobile phones and PDAs (Personal Digital Assistants) are now in widespread use, and consumers may now enjoy the full convenience of high technology products almost anytime and anywhere. Foldable electronic devices are particularly favored by a wide range of consumers due to their small size, novel design and ease of use. One of the advantages of the foldable design is that accidental activation of keys/buttons can be avoided by covering the keypad with the cover of the electronic device.

The foldable mobile phone generally includes a cover section and a body section. The cover section and the body section are rotatably interconnected through a hinge assembly, thus allowing the mobile phone to be switched between an in-use position and a closed position. One kind of hinge assembly employs a cam and a follower, which makes the cover section fold outward from the body section and then stays in an open position. The hinge assembly typically includes a cam having a concave portion, a follower having a convex portion, a shaft having a fixing end, and a spring. The cam and the follower are placed around the shaft. The spring resists the follower to tightly contact the concave portion with the convex portion. The cam, the follower, the shaft and the spring are received in a housing. A flip cover rotates about a main body of the mobile phone by overcoming the force of the spring, thus making the concave portion rotate about the convex portion. However, a user must open the mobile phone using both hands. This makes the mobile phone difficult to use in situations when the user has only one hand free.

Therefore, a new hinge mechanism is desired in order to overcome the above-described shortcoming.

### SUMMARY OF THE INVENTION

One embodiment of the present hinge assembly includes a main shaft, a fixing seat, a follower, a cam and a first elastic element. The fixing seat is fixed with the main shaft. The follower is placed around the shaft, and the fixing seat selectively locks with the follower. The cam is placed around the shaft and engages with the follower. The first elastic element provides an elastic force for resisting the cam and the follower with each other and provides a torsional force to make the cam and the follower rotate together.

Other advantages and novel features of the present hinge assembly will become more apparent from the following detailed description thereof when taken in conjunction with the accompanying drawings.

### BRIEF DESCRIPTION OF THE DRAWINGS

Many aspects of the hinge assembly can be better understood with reference to the following drawings. The components in the drawings are not necessarily drawn to scale, the emphasis instead being placed upon clearly illustrating the principles of the present hinge assembly. Moreover, in the drawings, like reference numerals designate corresponding parts throughout the several views, in which:

FIG. 1 is an assembled view of an embodiment of the present hinge assembly;

FIG. 2 is an exploded, isometric view of the embodiment of the hinge assembly shown in FIG. 1;

FIG. 3 is a schematic view of the sleeve of FIG. 2;

FIG. 4 is a schematic view of the elastic element of FIG. 2;

FIG. 5 is a schematic view of the cam and the follower of FIG. 2;

FIG. 6 is similar to FIG. 5, but viewed from another aspect;

FIG. 7 is a schematic view of the main shaft of FIG. 2;

FIG. 8 is a schematic view of the locking element of FIG. 2;

FIG. 9 is a schematic view of the fixing seat of FIG. 2;

FIG. 10 is similar to FIG. 9, but viewed from another aspect;

FIG. 11 is a schematic view of the pressing element of FIG. 2;

FIG. 12 is an isometric view of the embodiment of the present hinge assembly, as used in a mobile phone;

FIG. 13 is similar to FIG. 2, but showing the hinge assembly in a position corresponding to a close state of the mobile phone; and

FIG. 14 is similar to FIG. 2, but showing the hinge assembly in a position corresponding to an open state of the mobile phone.

### DETAILED DESCRIPTION OF THE INVENTION

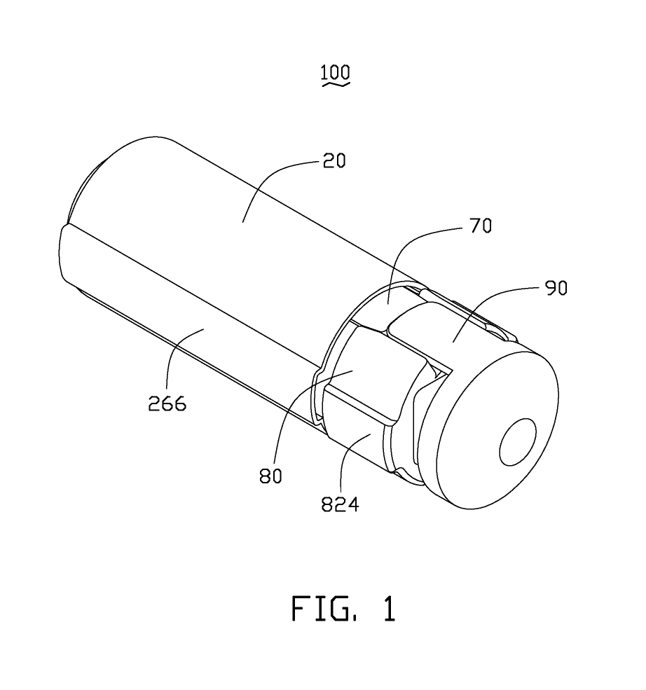

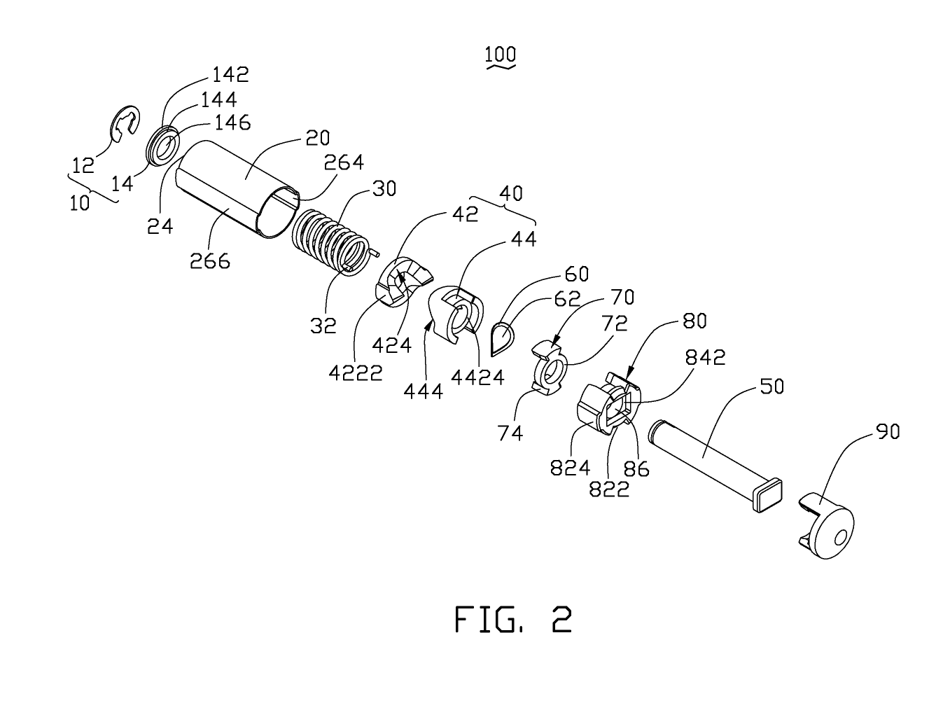

Referring to FIGS. 1 and 2, the hinge assembly 100, in one illustrated embodiment, includes a fixing group 10, a sleeve 20, a first elastic element 30, a cam group 40, a main shaft 50, a second elastic element 60, a locking element 70, a fixing seat 80 and a pressing element 90.

The fixing group 10 includes a ring 12 and a washer 14. The ring 12 is substantially C-shaped, and is used for fixing with one end of the main shaft 50. The washer 14 is substantially disk-shaped, and includes a cylindrical body 142 and a stage 144. The stage 144 is formed on one side of the cylindrical body 142. The washer 14 defines a through hole 146 in a central area thereof.

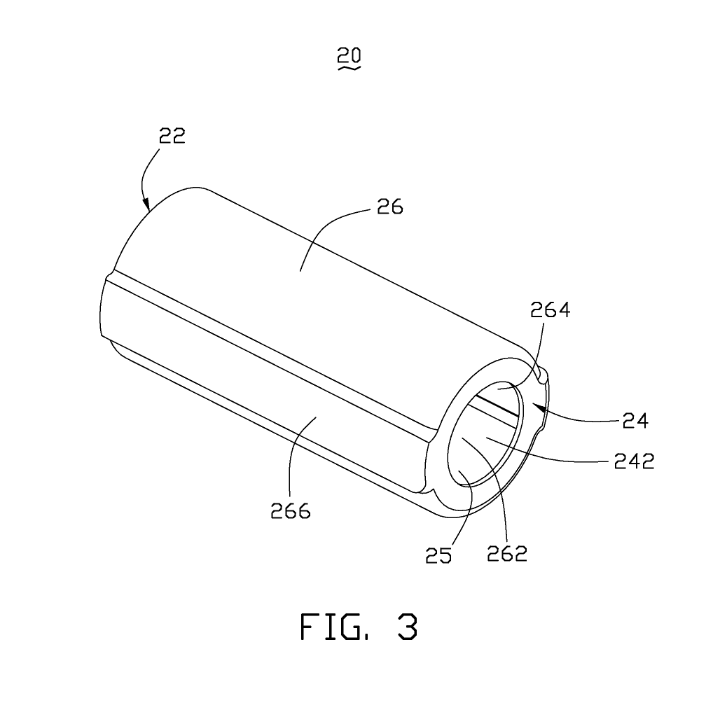

Referring to FIG. 3, the sleeve 20 is substantially a hollow cylinder having an inner wall 25 and outer wall 26, and includes an open end 22 and a half-closed end 24. The inner wall 25 together with the half-closed end 24 defines a cavity 262 therebetween. The half-closed end 24 defines a through hole 242. The through hole 242 is sized to be a little bit larger than the stage 144 of the washer 14, and is smaller than the cylindrical body 142. Accordingly, the through hole 242 is configured for receiving the stage 144 of the washer 14 while the half-closed end 24 blocks the stage 144 of the washer 14. Two long troughs 264 are defined in an inner wall of the sleeve 20 and two sleeve blocks 266 are formed corresponding to the long troughs 264. The sleeve blocks 266 engage with a cover section of a mobile phone.

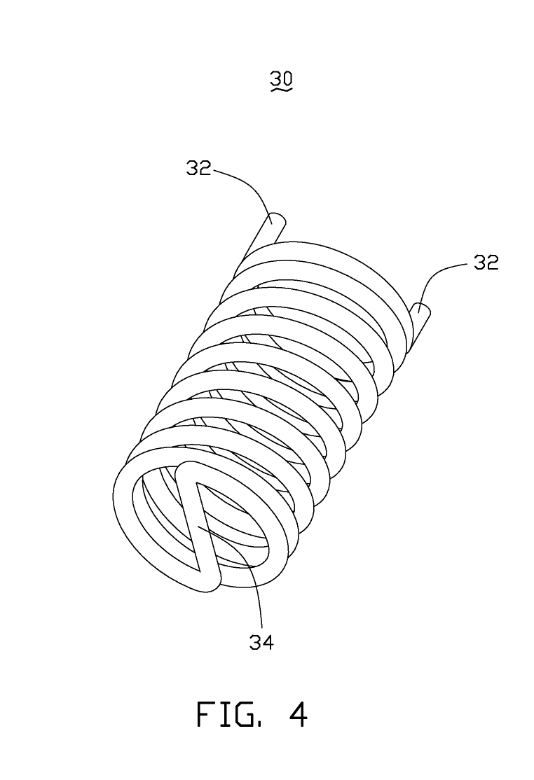

Referring to FIG. 4, the first elastic element 30 is a double helical spring which may be made by stainless steel wire in a circular motion. One end of the first elastic element 30 has two posts 32, and the other end thereof has a connecting portion 34. The two posts 32 are symmetrical to an axis of the first elastic element 30, and each post 32 is parallel with the axis of the first elastic element 30. The connecting portion 34 is a straight section in this embodiment, one end thereof being coiled and extended as a helical wire, and the other end thereof being coiled and extended as another helical wire, both helical wires being interspaced with each other while not interconnected with each other.

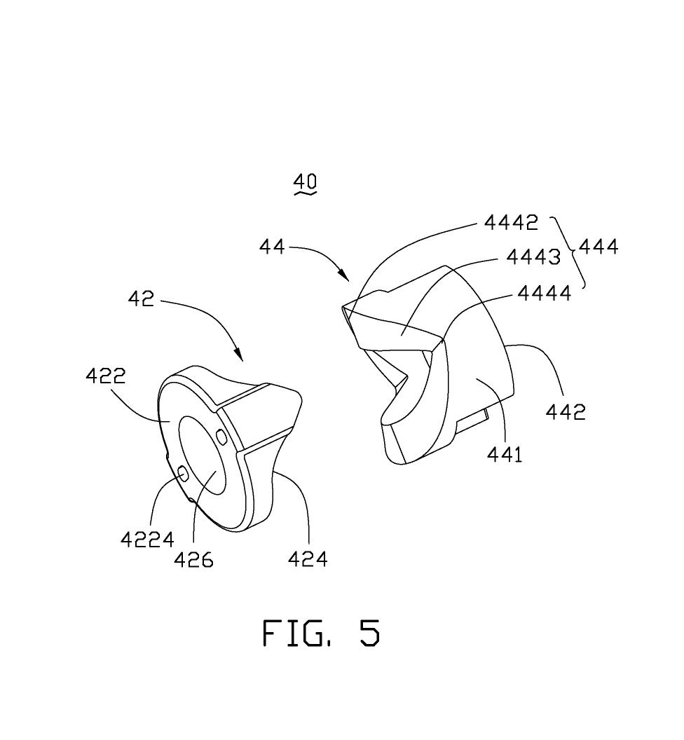

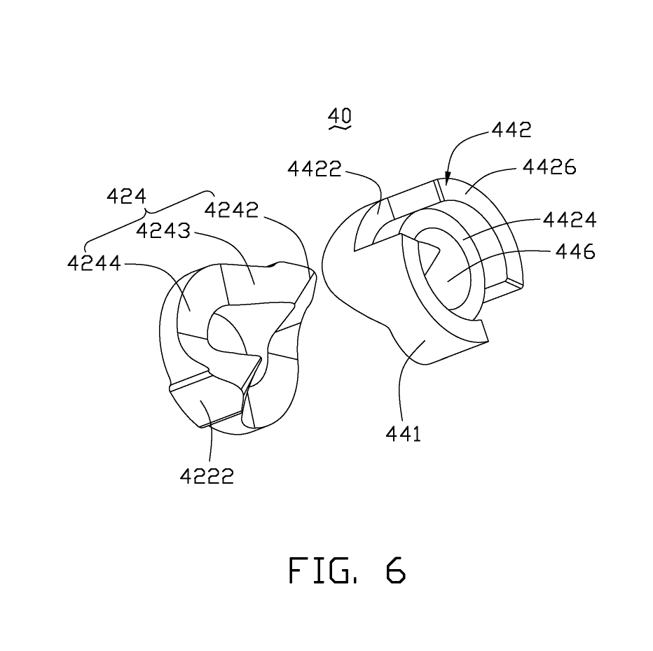

Referring to FIGS. 5 and 6, the cam group 40 includes a cam 42 and a follower 44. The cam 42 is substantially cylindrical, and includes a plane end 422 and a cam surface 424. The plane end 422 is opposite to the cam surface 424. A cam hole 426 is defined in a central area of the cam 42. The cam 42 has two spaced projections 4222 formed at an outer peripheral wall thereof configured for engaging in the troughs 264 of the sleeve 20. The plane end 422 defines two receiving holes 4224. Each receiving hole 4224 is used for receiving a corresponding post 32, thereby one end of the first elastic element 30 being fixed with the cam 42. The cam surface 424 includes two peaks 4242, two valleys 4244. Each valley 4244 is substantially a plane surface. Each peak 4242 and each valley 4244 is connected by an arcuate surface 4243.

The follower 44 is also substantially a cylinder in shape, and includes a periphery wall 441, an engaging end 442 and a latching cam surface 444. The follower 40 defines a follower hole 446 in a central area thereof. Two notches 4422 are defined in the periphery wall 441 of the follower 40 and in communication with the engaging end 442. The notches 4422 separate the periphery wall 441 into two opposite arms 4426. An inner circular wall 4424 is formed inside the periphery wall 441. The inner circular wall 4424 is lower than the periphery wall 441 thereby forming a step therebetween. The periphery wall 441 and the inner circular wall 4424 are coaxial. The latching cam surface 444 includes two peaks 4442 and two valleys 4444. Each peak 4442 and each valley 4444 is smoothly connected with an arcuate surface 4443.

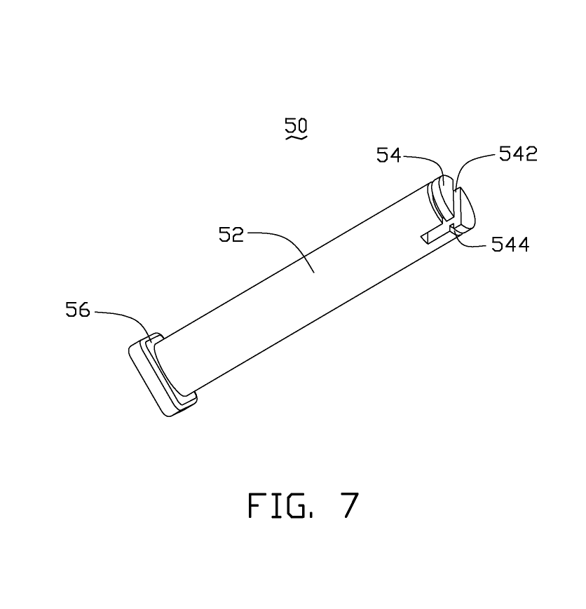

Referring to FIG. 7, the main shaft 50 includes a fixing portion 54, a flange portion 56 and a shaft portion 52 connected between the fixing portion 54 and the flange portion 56. The shaft portion 52 is cylindrical. The flange portion 56 is positioned at one end of the shaft portion 52. A cross sectional configuration of the flange portion 56 is in rectangular shape. The fixing portion 54 has a slot 542 defined along an axial direction of the main shaft 50, and divides the fixing portion 54 into two sections. The slot 542 is configured for receiving the connecting arm 34 of the first elastic element 30 so as to fix one end of the first elastic element 30 to the main shaft 50. The fixing portion 54 defines a loop groove 544 along a periphery thereof. The loop groove 544 is communicated with the slot 542.

The second elastic element 60 is a curved leaf spring with a through hole 62 defined therein. The second elastic element 60 is configured for being received inside the periphery wall 441 substantially contacting the inner circular wall 4424 of the follower 44. Owing to a small volume of the curved leaf spring, the hinge assembly 100 may have a shorter axial length, thereby requiring smaller space.

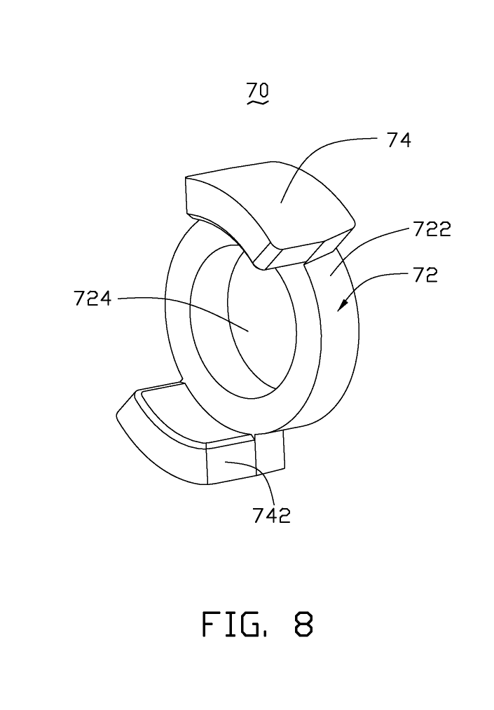

Referring to FIG. 8, the locking element 70 includes a cylindrical body 72 and two latching portions 74. An outer diameter of the cylindrical body 72 is similar to that of the round groove 4424 of the follower 40 so that the cylindrical body 72 can be completely received in the round groove 4424 of the follower 40. The cylindrical body 72 defines a central hole 724 so as to allow the locking element 70 to place around the main shaft 50. The two latching portions 74 respectively extend from two sides of an outer peripheral wall of the cylindrical body 72, thereby forming two engaging grooves 722. The engaging grooves 722 are used for receiving a corresponding extending arm 4426 of the follower 40. Each latching portion 74 has an extending portion 742, which extends beyond the cylindrical body 72. The extending portions 742 are used for engaging in the notches 4422 of the follower 44.

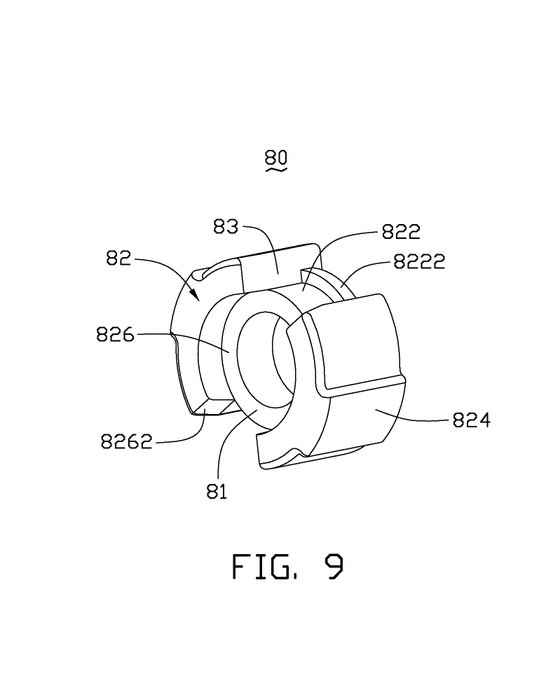

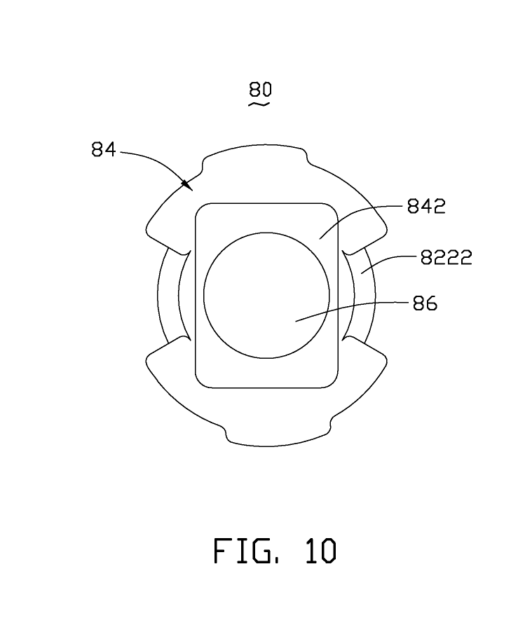

Referring to FIGS. 9 and 10, the fixing seat 80 is substantially a hollow cylinder in shape. The fixing seat 80 includes a seat body 81 and two surrounding portions 83. The two surrounding portions 83 surround two sides of the seat body 81, thereby defining a receiving space 822 therebetween. An outer peripheral wall of each surrounding portion 83 forms a protrusion 824 configured for engaging with a body section of a mobile phone. An arcuate ridge 8222 is formed on the seat body 81 between the two surrounding portions 83. The fixing seat 80 includes a first end 82 and a second end 84. A height of the surrounding portions 83 is larger than that of the seat body 81, thereby forming an engaging space 826 at the first end 82. The engaging space 826 communicates with the receiving space 822. The receiving space 822 is substantially cylindrical, and a diameter of the receiving space 822 is similar to that of the cylindrical body 72 of the locking element 70. Each surrounding portion 83 has a projecting portion 8262, which extends beyond the seat body 81. Each projecting portion 8262 is used for engaging in a corresponding engaging groove 722. The second end 84, the seat body 81 and the surrounding portions 83 together define a rectangular groove 842. The seat body 81 defines a through hole 86. The through hole 86 communicates with the rectangular groove 842.

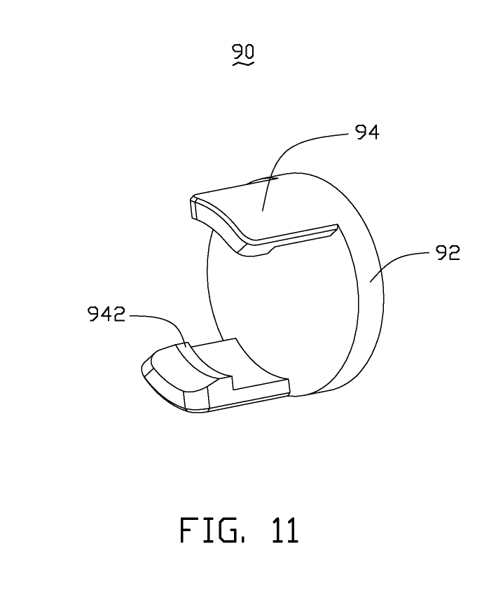

Referring to FIG. 11, the pressing element 90 is substantially disk-shaped, and includes a cylindrical body 92 and two arms 94. The arms 94 respectively extend from one side of the cylindrical body 92. A length of the arms 94 is similar to that of the receiving space 822 of the fixing seat 80 so that the arms 94 can be received in the receiving space 822. Each arm 94 has a clasp 942 formed at an inner side of one end thereof. The clasps 942 are used for engaging with the ridges 8222 of the fixing seat 80 so as to prevent the pressing element 90 detaching from the fixing seat 80.

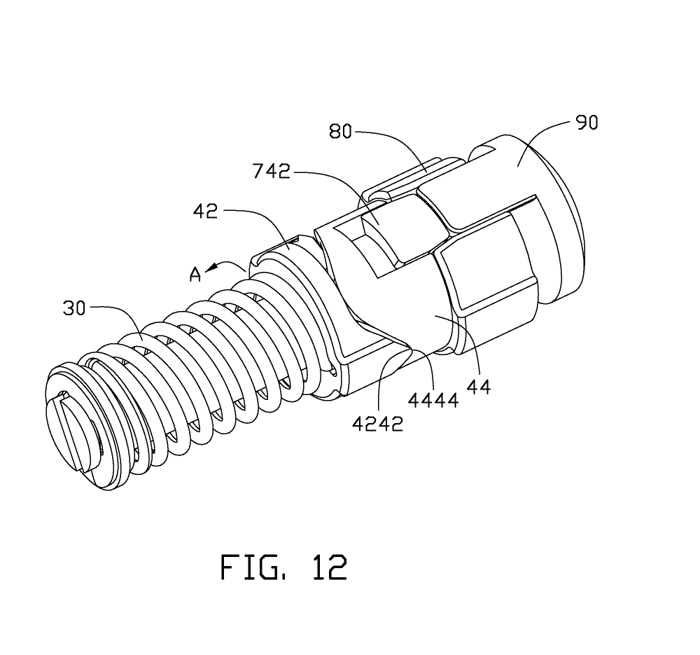

In assembly, referring to FIG. 12, the fixing seat 80 is placed around the main shaft 50, with the flange portion 56 of the main shaft 50 received in the rectangular recess 842 of the fixing seat 80. Then, the locking element 70 is placed around the main shaft 50, and the cylindrical body 72 of the locking element 70 is received in the engaging space 826. The extending portions 742 of the latching portions 74 of the locking element 70 are engaged in the receiving spaces 822 of the fixing seat 80, at the same time, the projecting portions 8262 of the fixing seat 80 are received in the engaging grooves 722 of the locking element 70. The second elastic element 60 is placed around the main shaft 50 with the through hole 62, and one end of the elastic element 60 resists the cylindrical body 72. After that, the follower 44 is placed around the main shaft 50. The round groove 4424 of the engaging end 442 receives the other end of the second elastic element 60. The extending portions 742 of the latching portions 74 of the locking element 70 are received in the notches 4422 of the follower 44.

Next, the cam 42 is placed around the main shaft 50, with the cam surface 424 of the cam 42 engaging with the latching cam surface 444 of the follower 44. The first elastic element 30 is placed around the main shaft 50. The posts 32 of the first elastic element 30 are inserted into the receiving holes 4224 of the cam 42. The connecting portion 34 of the first elastic element 30 is received in the slot 542 of the main shaft 50. After the above elements are assembled, the sleeve 20 is placed around the main shaft 50. The cavity 262 of the sleeve 20 receives the first elastic element 30, the cam 42, the follower 44, the second elastic element 60 and the locking element 70. The open end 22 of the sleeve 20 is adjacent to the fixing seat 80. The half-closed end 24 of the sleeve 20 resist the first elastic element 30. The projections 4222 of the cam 42 are engaged in the trough 264 of the sleeve 20 so as to limit the rotation therebtween.

The fixing portion 54 is extended from the half-closed end 24 of the sleeve 20. The washer 14 is placed around the fixing portion 54 of the main shaft 50. The stage 144 of the washer 14 is received in the through hole 242 of the sleeve 20, and the cylindrical body 142 of the washer 14 resists the half-closed end 24 of the sleeve 20. The ring 12 is placed around the loop groove 544 of the main shaft 50, and the ring 12 resists the washer 14. Finally, the pressing element 90 is engaged with the fixing seat 80, with the arms 94 engaging in the notches 822 of the fixing seat 80. Therefore, the assembled process of the hinge assembly 100 is completed.

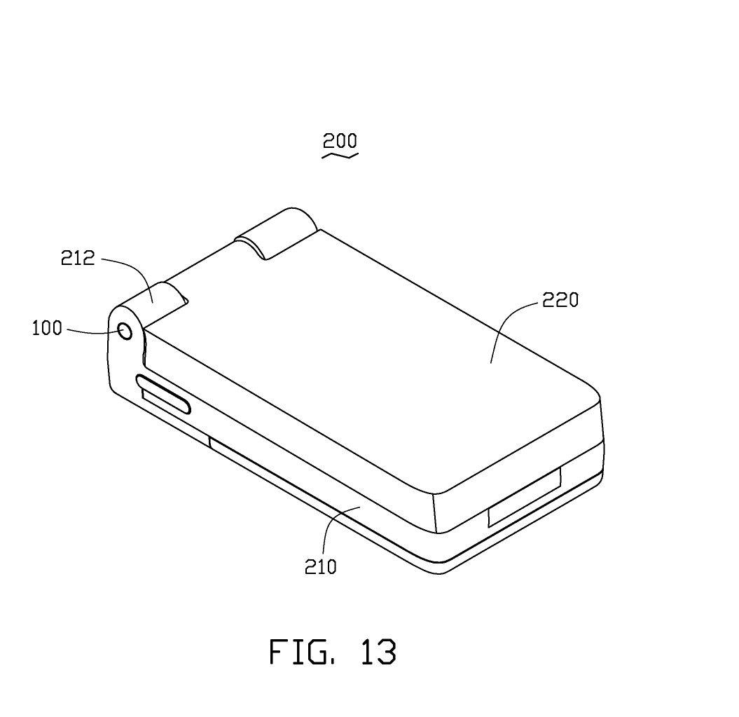

Referring to FIG. 13, the hinge assembly 100 is applied to a portable electronic device 200 such as a flip type mobile phone. It is to be understood, however, that the hinge assembly 100 could be advantageously used in other situations (e.g. cabinet doors). As such, although proving particularly advantageous when used in foldable electronic devices, the hinge assembly 100 should not be considered limited in scope solely to them.

The mobile phone 200 includes a body section 210 and a cover section 220. The hinge assembly 100 pivotably couples the body section 210 and the cover section 220. The body section 210 forms two fixing cylindrical portions 212. The fixing cylindrical portions 212 are non-rotatably connected with the protrusions 824 of the fixing seat 80. The cover section 220 is non-rotatably connected with the sleeve blocks 266 of the sleeve 20. When the cover section 220 of the mobile phone 200 is in a fully closed position, the peaks 4242 of the cam surface 424 of the cam 42 resist the valleys 4444 of the latching cam surface 444 of the follower 44. The first elastic element 30 has a predetermined pressure and a predetermined torsion. The predetermined pressure is exerted on the cam 42 so that the cam 42 resists the follower 44. The predetermined torsion of the first elastic element 30 is exerted on the cam 42 so that the cam 42 has a rotation tendency relative to the main shaft along an A direction, referring to FIG. 12. Since the extending portions 742 of one end of the latching portions 74 are locked in the notches 4422, the other end of the latching portions 74 are received in the receiving spaces 822 of the fixing seat 80, the locking element 70 is limited to rotate relative to the fixing seat 80. Accordingly, the locking element 70 further limits the follower 44 to rotate relative to the cam 42. Furthermore, owing to a frictional force between the cam 42 and the follower 44 larger than the torsional force of the first elastic element 30, the first elastic element 30 cannot bring the cam 42 to rotate relative to the follower 44. Therefore, the cam 42 is prevented from rotating by the locking element 70.

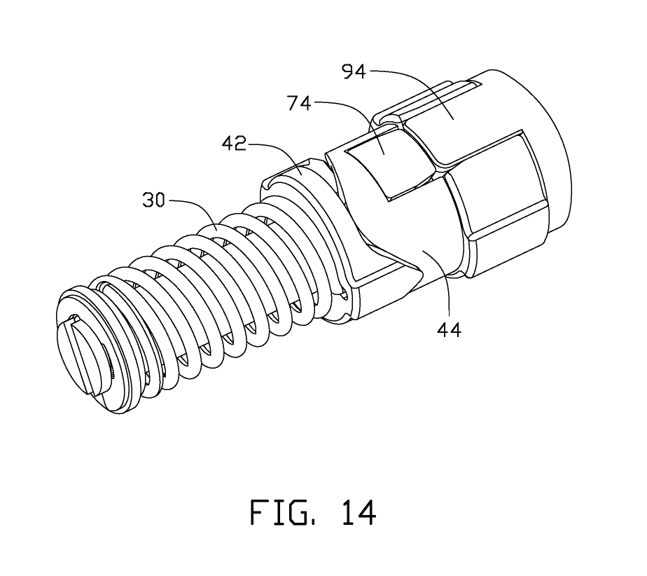

In use, referring to FIG. 14, when the user wants to open the cover section 220 of the mobile phone 200 automatically, he/she may push the pressing element 90. The pressing element 90 moves axially so that the pressing element 90 pushes the locking element 70 towards the cam 42. When the latching portions 74 of the locking element 70 detach from the receiving spaces 822 of the fixing seat 80, the torsional force of the first elastic element 30 brings the follower 44 and the cam 42 to rotate relative to the main shaft 50.

Furthermore, the cam 42 makes the sleeve 20 rotate so that the cover section 220 of the mobile phone 200 is opened. The cam 42 stops rotating after the cover section 220 of the mobile phone 200 is completely opened. The elastic potential energy of the second elastic element 60 then pushes the locking element 70 in a reverse direction towards the fixing seat 80. Accordingly, the latching portions 74 of the locking element 70 are locked between the receiving spaces 822 of the fixing seat 80.

When the cover section 220 of the mobile phone 200 is closed, the cover section 220 causes the sleeve 20 to rotate relative to the body section 210. The sleeve 20 further brings the cam 42 to rotate relative to the main shaft 50. Because the locking element 70 is locked into the receiving spaces 822 of the fixing seat 80, the locking element 70 cannot rotate relative to the fixing seat 80. Accordingly, the locking element 70 and the follower 44 do not rotate relative to the fixing seat 80. Thus, the cam 42 rotates relative to the follower 44. When the cam 42 rotates, the follower 44 is pushed toward the fixing seat 80. When the cam 42 rotates out from the valleys 4444 of the follower 44, the first elastic element 30 accumulates elastic potential energy and torsional force. When still exerting a force, the peaks 4242 of the cam 42 slide over the peaks 4442 of the follower 42. When this outer force is released, the cam 42 automatically slides into next valley 4444 of the follower 44. Accordingly, the cover section 220 becomes closed relative to the body section 210 of the mobile phone 200.

The hinge assembly 100 may be opened manually. When the cover section 220 of the mobile phone 200 is opened, the cover section 220 causes the sleeve 20 to rotate relative to the body section 210. The sleeve 20 further brings the cam 42 to rotate relative to the main shaft 50. Because the latching portions 74 is locked into the receiving spaces 822 of the fixing seat 80, the locking element 70 cannot rotate relative to the fixing seat 80. Accordingly, the locking element 80 and the follower 44 do not rotate relative to the fixing seat 80. Thus, the cam 42 rotates relative to the follower 44. When the cam 42 rotates, the cam 42 is pushed toward the washer 14. When the cam 42 rotates out from the valleys 4444 of the follower 44, the peaks 4242 of the cam 42 pass over the peaks 4442 of the follower 44. Accordingly, the cover section 220 becomes open relative to the body section 210 of the mobile phone 200.

A main advantage of the hinge assembly is that the first elastic element 30 adopts a double helical spring structure, and has a torsional force and a pressure. The torsional force of the first elastic element 30 may bring the cover section to automatically be opened. In addition, the second elastic element 60 adopts a curved leaf spring so that the hinge assembly may have a small volume. Furthermore, the washer 14 is disposed between the ring 12 and the sleeve 20. Therefore, the abrasion between the sleeve 20 and the ring 12 is thus greatly reduced.

In an alternative embodiment, the first elastic element 30 and the second elastic element 60 may be replaced by other elastic elements such as elastic sponges.

In an alternative embodiment, the locked member 70 may be omitted. Accordingly, the locked member 70 directly contacts with the follower 44, and the second elastic element 60 directly resist the follower 44.

As described above, the present invention provides a hinge assembly 100 for use with various portable devices, beyond the mobile phone illustrated, and/or with other devices requiring a hinge assembly that selectably facilitates the fully open and fully closed positions.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A hinge assembly, comprising:
a main shaft;
a fixing seat being fixed with the main shaft;
a follower placed around the shaft, the fixing seat selectively locked with the follower;
a cam placed around the shaft, and engaging with the follower; and
a first elastic element providing an elastic force to make the cam and the follower resist each other and providing a torsional force to make the cam and the follower rotate together.

2. The hinge assembly as claimed in claim 1, wherein one end of the first elastic element has at least one post, and the other end thereof has a connecting portion, the at least one post is fixed with the cam, and the connecting portion is fixed with the main shaft.

3. The hinge assembly as claimed in claim 2, wherein the number of the posts is two, and the two posts are symmetrical to and are parallel with an axis of the first elastic element.

4. The hinge assembly as claimed in claim 3, wherein the first elastic element is a double helical spring, and the connecting portion is a straight line section from two ends of which the double helical spring is bent and reversely wound.

5. The hinge assembly as claimed in claim 2, wherein the main shaft has a fixing portion at one end thereof, the fixing portion defines a slot along an axial direction thereof, and the connecting portion of the first elastic element is received in the slot.

6. The hinge assembly as claimed in claim 5, further comprising a ring, wherein the fixing portion defines a loop groove, the loop groove communicates with the slot, and the ring is locked in the loop groove.

7. The hinge assembly as claimed in claim 1, further comprising a locking element, wherein the locking element is positioned between the follower and the fixing seat.

8. The hinge assembly as claimed in claim 7, further comprising a second elastic element, the second elastic element is positioned between the locking element and the follower.

9. The hinge assembly as claimed in claim 8, wherein the second elastic element is a curved leaf spring that has a through hole defined therein.

10. The hinge assembly as claimed in claim 1, further comprising a pressing element having two arms, wherein the fixing seat includes a seat body and two surrounding portions, the surrounding portions surrounding the seat body so as to form two receiving spaces therebetween, and the arms are received in the receiving spaces.

11. The hinge assembly as claimed in claim 10, further comprising a locking element having two latching portions extending therefrom, wherein the follower defines two notches at one end thereof, the latching portions engaging in the notches of the follower and the receiving spaces of the fixing seat, and the arms of the pressing element resist the latching portions of the locking element.

12. The hinge assembly as claimed in claim 1, wherein the fixing seat defines a rectangular groove, the main shaft has a flange portion that is fixed in the rectangular groove.

13. A hinge assembly of a foldable electronic device comprising a main body and a flip cover, the hinge assembly comprising:
a main shaft;
a cam movably positioned around the shaft, the cam having a cam surface, the cam being configured so as to be fixed relative to one of the main body and the flip cover;
a follower movably positioned around the main shaft, the follower having a latching cam surface engaging with the cam surface of the cam;
a first elastic member providing a torsional force to the cam;
a fixing seat configured to be fixed relative to the other of the main body and the flip cover;
a locking element engaged with the fixing seat and the follower, the locking element being movable between a locked position where the locking element is engaged with the fixing seat and the follower in a manner so as to prevent the cam from rotating relative to the fixing seat under the torsional force of the first elastic element, and an unlocked position where the locking element is released from the fixing seat and movable relative to the fixing seat; and
a second elastic member positioned between the locking element and the follower.

14. The hinge assembly as claimed in claim 13, wherein one end of the first elastic element has at least one post, and the other end thereof has a connecting portion, the at least one post is fixed with the cam, and the connecting portion is fixed with the main shaft.

15. The hinge assembly as claimed in claim 13, further comprising a pressing element having two arms, wherein the fixing seat includes a seat body and two surrounding portions, the surrounding portions surround the seat body so as to form two receiving spaces therebetween, and the arms are received in the receiving spaces.

16. The hinge assembly as claimed in claim 15, wherein the locking element has two latching portions, the follower defines two notches at one end thereof, and the latching portions engage in the notches of the follower and the receiving spaces of the fixing seat, and the arms of the pressing element resist the latching portions of the locking element.

17. A foldable electronic device having at least two components hinged together by a hinge assembly, the hinge assembly comprising:
a main shaft;
a fixing seat being fixed with the main shaft;
a follower placed around the shaft, the fixing seat selectively locked with the follower;
a cam placed around the shaft, the cam engaging with the follower by means of a cam engagement; and
a first elastic element providing a torsional force to make the cam and the follower rotate together when the fixing seat releases the follower.

18. The foldable electronic device as claimed in claim 17, wherein the hinge assembly further comprises a locking element that selectively locks the follower from rotation with respect to the fixing seat.

19. The foldable electronic device as claimed in claim 18, further comprising a pressing element having two arms, wherein the fixing seat includes a seat body and two surrounding portions, the surrounding portions surround the seat body so as to form two receiving spaces therebetween, and the arms are received in the receiving spaces.

20. The foldable electronic device as claimed in claim 19, wherein one end of the first elastic element has at least one post, and the other end thereof has a connecting portion, the at least one post being fixed with the cam, and the connecting portion being fixed with the main shaft.
